(19) United States
(12) Patent Application Publication
(10) Pub. No.: US 2026/0048600 A1
(43) Pub. Date: Feb. 19, 2026

(54) METHOD IN A LABEL PRINTER

(71) Applicant: Dover Europe Sàrl, Vernier (CH)

(72) Inventor: Jonas Södergård, Vastra Frolunda (SE)

(21) Appl. No.: 19/100,431

(22) PCT Filed: Aug. 1, 2023
(86) PCT No.: PCT/EP2023/071341

§ 371 Date: Jan. 31, 2025

(30) Foreign Application Priority Data
Aug. 1, 2022 (SE) 2250937-6
Aug. 1, 2022 (SE) 2250938-4
Aug. 1, 2022 (SE) 2250939-2
Aug. 1, 2022 (SE) 2250940-0
Aug. 1, 2022 (SE) 2250941-8
Aug. 1, 2022 (SE) 2250942-6
Aug. 1, 2022 (SE) 2250943-4
Aug. 1, 2022 (SE) 2250944-2

(51) Int. Cl. B41J 11/42; B41J 3/407; B41J 15/04; B41J 15/16; B65C 9/00; B65C 9/42

(52) U.S. Cl. CPC B41J 11/42; B41J 3/4075; B41J 15/04; B41J 15/16; B65C 9/42; B65C 2009/0084

(57) ABSTRACT

The specification relates to a method in a label printer (100), the label printer at least comprising: a label supply spool (120) configured to supply a label web comprising a label (191) and a carrier (191); a label rewinder (130) configured to rewind at least the carrier; a drive roller (172). The method comprises: operating the label rewinder in an opposite direction to a rewind direction and building or continue to build an extension (195) on the carrier between the drive roller (172) and the carrier rewinder (130) during a backfeed operation of the label web; performing a backfeed operation by rotating the drive roller (172) in a direction opposite to the print operation direction until a next label is displaced back to a start print position; stopping the drive roller after backfeed when a length of the extension (195) is reduced; and rewind with the rewinder (130) in rewinder operation direction causing the carrier to tense.

### TECHNICAL FIELD

The disclosure relates generally to an arrangement in a printer and in particular aspects, the disclosure relates to an arrangement in a printer for feeding media especially a label. The device of disclosure can be applied in industrial printer applications in general and label printers, in particular.

### BACKGROUND

A labelling machine is used to apply labels to packaging or products. In addition to applying labels, some labelling machines are capable of producing them, e.g., in cooperation with a label printing machine. A labelling printer or a standalone labelling machine may comprise a tape drive which advances the label stock from a supply spool support to a take up spool support. The tape drive may have a drive roller of known diameter which is accurately driven to achieve desired linear movement of the label stock along the web path. The label stock may be pressed against the drive roller by a nip roller, in order to mitigate risk of slip between the drive roller and the label stock. Labels are removed from the moving backing paper by passing the label stock under tension around a labelling peel beak, or a peel blade or a label separating beak under a predetermined optimum tension in the backing paper of the label stock.

There is a growing demand for sustainable products and solutions, particularly in every stage of product manufacturing. Label printers and especially industrial label printers are utilized at various points in a production line and are included in sustainability requirements. Industrial label printers are specifically designed for heavy-duty, continuous use in larger-scale labelling operations commonly found in warehouses, factories, and distribution centres. These printers can produce thousands of labels per day. Additionally, industrial label printers may also include a label application component, collectively referred to as Print and Apply (P&A) machines.

In a label printer, normally the backing paper/liner must be put under correct or appropriate tension as the label is fed forward to ensure the label is correctly peeled off. Between two prints, the paper track may need to be reversed, so called backfeed, for a distance to ensure that the print head can cover the entire label. During the backfeed process, the tension in the backing paper should be released. Ideally, the tension should be released to the extent that a slack is created between the dispensing edge and the backing paper rewinder. This prevents excessive friction between the dispensing edge and the backing paper, which may cause slippage between the backing paper and the drive roller. Such slippage could lead to errors in the label printing and feeding process.

There are two known methods to achieve the above scenario:

The most common solution is to have a separate backing paper/liner tensioner unit between the dispensing edge and the rewinder. The tensioner can range from a single roller to a more complex design. Regardless of its design, the tensioner's purpose is to maintain constant tension in the backing paper/liner, unaffected by the actions of the rewinder or the amount of backing paper on it. While this method works well, it adds complexity and time when changing labels.

When no tensioner is used between the dispensing edge, the label change process is simplified, but high-speed operation becomes less reliable. The typical solution can be torque control, where the torque of the backing paper rewinder is adjusted according to the rewinder diameter (D) during the printing process. The backing paper rewinder runs in reverse for a specific period during backfeed to create slack in the backing paper.

However, when the rewinder and the backing paper are re-stretched immediately after a backfeed, there is a risk of a “bouncing” effect in the backing paper. If no additional tensioner mechanism is used, there is a risk of insufficient tension, which could result in a failed printout due to the label not being properly peeled off from the backing paper.

### SUMMARY

The present disclosure presents methods and arrangements that can be used to design a label printer that is both easy to use and reliable in high-speed operation. The methods and arrangements of the present disclosure enable overcoming one or several of mentioned shortcomings of the label printers and P&A systems.

The objectives are achieved:

According to a first aspect, a method is disclosed in a label printer, the label printer at least comprising: a label supply spool configured to supply a label web comprising a label and a carrier; a label rewinder configured to rewind at least the carrier; a drive roller. The method comprises: operating the label rewinder in an opposite direction to a rewind direction and building or continue to build an extension on the carrier between the drive roller and the carrier rewinder during a backfeed operation of the label web; performing a backfeed operation by rotating the drive roller in a direction opposite to the print operation direction until a next label is displaced back to a start print position; stopping the drive roller after backfeed when a length of the extension is reduced; and rewind with the rewinder in the rewinder operation direction causing the carrier to tense.

According to a second aspect, a method of printing a label in a label printer is disclosed. The label printer comprising: a label supply spool configured to supply a label web comprising a label attached to a carrier; a label rewinder configured to receive at least the carrier of the label web and rotationally operatable by a label rewinder motor; a drive roller. The method comprising: during a print operation: rewinding the carrier by means of the rewinder with controlled torque; if an ongoing extension removal operation: in a first period of time rewind with a controlled speed, and in a second period of time rewind with a second speed higher than a surface speed of the drive roller; during an optional non-printing operation: rewinding the carrier by means of the rewinder by controlling the speed; during a backfeed operation: creating an extension, substantially with known size, in the carrier by controlling the speed of the rewinder in a opposite direction; and during an extension removal operation: rewinding the carrier with the rewinder, wherein the rewinder: in a first period of time has a controlled speed, and in a second period of time has a second speed higher than a surface speed of the drive roller.

According to a third aspect, a method of printing a label in a label printer is disclosed. The label printer comprising: a label supply spool configured to supply a label web comprising a label attached to a carrier; a label rewinder configured to receive at least the carrier of the label web and rotationally operatable by a label rewinder motor; a drive roller. the method comprising: during a print operation: rewinding the carrier by means of the rewinder with controlled torque; if an ongoing extension removal operation: in a first period of time rewind with a controlled speed, and in a second period of time rewind with a second speed higher than a surface speed of the drive roller; during a non-printing operation: rewinding the carrier by means of the rewinder by controlling the speed; during a backfeed operation: creating an extension, substantially with known size, in the carrier by controlling the speed of the rewinder in a opposite direction; and during an extension removal operation: rewinding the carrier with the rewinder speed or torque controlled.

According to a fourth aspect a label printer is provided at least comprising: a label supply spool configured to supply a label web comprising a label and a carrier; a label rewinder configured to rewind at least the carrier; a drive roller; and a controller. The controller is configured to: instruct the label rewinder to operate in an opposite direction to a rewind direction and building or continue to build an extension on the carrier between the drive roller and the carrier rewinder during a backfeed operation of the label web; instruct the rewinder to a backfeed operation by rotating the drive roller in a direction opposite to the print operation direction until a next label is displaced back to a start print position; stop the drive roller after backfeed when a length of the extension is reduced; and instruct the rewinder to rewind in the rewinder operation direction causing the carrier to tense.

According to a fifth aspect, the objective is achieved by a control unit for enabling a label to be applied on an object. The control unit is arranged to perform the methods of the first to third aspect.

According to a sixth aspect, the objective is achieved by a computer program product comprising program code for performing, when executed by a processing circuitry, the methods of the first to third aspect.

According to a seventh aspect, the objective is achieved by a non-transitory computer-readable storage medium comprising instructions, which when executed by a processing circuitry, cause the processing circuitry to perform the methods of the first to third aspect.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above discussed technical benefits.

### BRIEF DESCRIPTION OF THE DRAWINGS

With reference to the appended drawings, below follows a more detailed description of aspects of the disclosure cited as examples. Reference is made to the attached drawings, wherein elements having the same reference number designation may represent like elements throughout.

FIG. 1 depicts an exemplary printer in which teachings of the disclosure can be implemented;

FIG. 2 illustrates the printer of FIG. 1 form another side;

FIGS. 3a to 3c illustrate schematically the printhead and dispensing portion of the printer of FIG. 1 in different operational state;

FIGS. 4a and 4b are exemplary graphical representation of the speed of the drive roller over time, presented with dotted line and the combined speed of the drive roller and backing paper rewinder surface speed represented by solid line;

FIG. 5 is an exemplary graphical representation of the combined speed of the drive roller and backing paper rewinder surface speed;

FIG. 6 is a flow diagram illustrating steps of an exemplary method;

FIG. 7 is an exemplary representation of the backing paper rewinder setup, and

FIG. 8 is an exemplary schematic controller according to one aspect of the disclosure;

### DETAILED DESCRIPTION

The term “industrial printer”, also known as an “industrial-grade printer”, as used herein, may refer to a type of printer specifically designed for heavy-duty printing tasks in industrial environments. These types of printers are built to handle large volumes of printing, often with high-speed and precision, and are capable of printing on various materials such as paper, cardboard, labels, plastics, and metals. The industrial printers, as referred to herein, may commonly be used in sectors like manufacturing, logistics, packaging, and retail, where there is a need for efficient and reliable printing solutions.

They are typically more robust and durable compared to standard office printers, as they are required to withstand harsher conditions and extended operation periods.

The terms “ribbon”, “color ribbon” or “ink ribbon” as used herein may generally refer to a consumable component used to transfer ink onto the printing media, typically paper or labels.

The term “label”, as used herein, may include an information carrier media which can be made of several types of materials, depending on the specific requirements and application. Some common materials used for printer labels may for example include (but not limited to): paper, synthetic materials, cardstock, clear and transparent materials, thermal labels, and specialty materials.

The term “backing paper” or “liner”, as used herein, may refer to a conveyor comprising different materials on which an information carrier to be printed is dispensed.

The term “slack” or “extension”, as used herein, may refer to a loose or excess portion of the backing paper material that is not stretched or under tension.

The terms “rewinder”, as used herein may refer to an arrangement, to collect label carrier/backing paper (with or without labels on it).

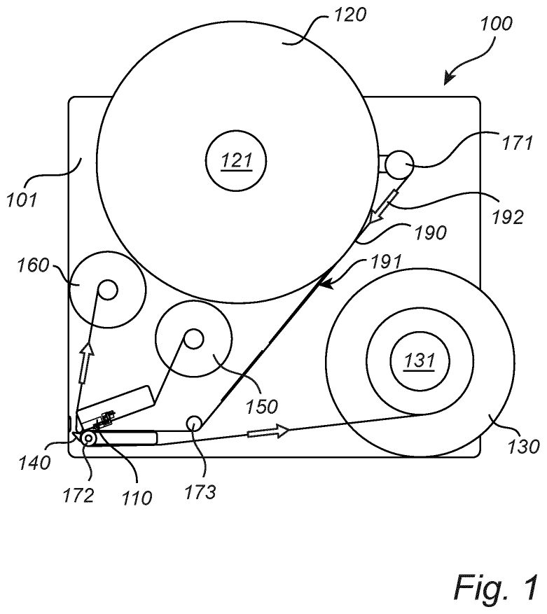

FIG. 1 illustrates, from one side, an exemplary label printer apparatus 100 in which teachings of the present disclosure may be implemented. The printer apparatus 100 comprises a support wall 101 on which are mounted a printhead 110, a label supply spool 120 of label stock mounted to a supply spool support 121, a take up spool or rewinder 130, an ink ribbon supply spool 150, an ink ribbon take-up spool 160, and a number of rollers 171, 172 and 173. Each label supply spool 120, rewinder 130 and roller 172 may directly or indirectly be driven by respective motor or one or several motors with gearing/driving arrangements.

During operation a label web comprising a backing paper or liner 190 with adhesive labels 191 extends along a web path 192 which runs from the label supply spool 120 around the first roller 171, around the second roller 173, over the second drive roller 172, around a labelling peel beak 140 and to the take up spool 130.

The ink ribbon may extend from the supply spool 150, passes the printhead's 110 print elements (not shown) and is wound onto the take up spool 160. In this embodiment, the print head 110 comprises a printhead, such as near edge printhead. Of course, other types of printheads may also be used. During the printing operation, the ink carried on the ribbon is transferred to the label web which is to be printed. To influence the transfer of ink, the printhead is brought into contact with the ribbon, and the ribbon is brought into contact with the label web 190, 191 and pressed onto the drive roller 172.

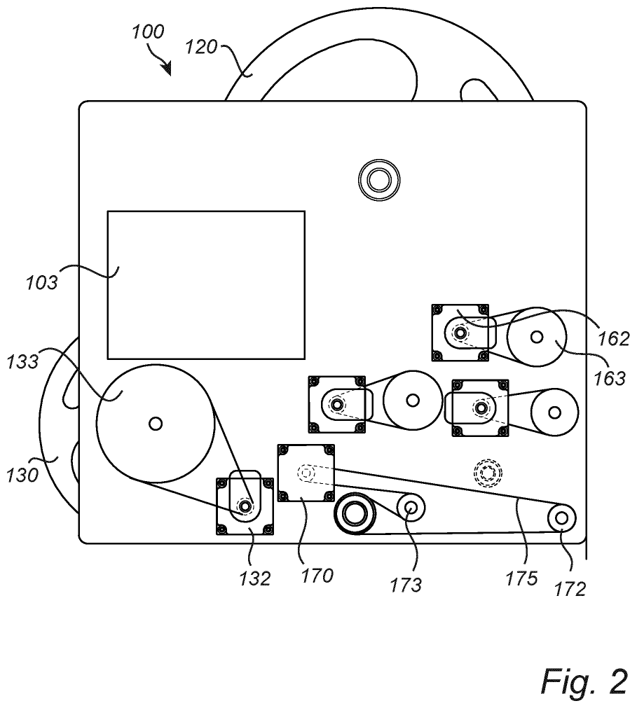

FIG. 2 illustrates the driving mechanisms for printer device 100 of FIG. 1 from the other side of the support wall 101. The rewinder 130 is driven by a motor 132 and a pulley 133 through a belt, the rollers 172 and 173 are driven by a motor 170 and driving belt 175, the ink ribbon supply 150 is driven by means of a motor 152 and a pulley 153 and the ribbon take up 160 is driven by means of a motor 162 and a pulley 163 through a belt. At least one controller 103 controls the various functions of the printer and also the operation of the motors.

According to one embodiment, a slack of a known length is created in the label web 190, 191 and the “bouncing” effect is resolved by making sure that the label web has a similar speed as the drive roller surface when the backing paper is re-stretched and the slack is reeled in.

The term “bouncing”, as used herein, may refer to a substantially sudden movement indicated by a motion characterized by optionally repeated, elastic impacts or jumps.

Briefly, this is achieved by utilizing rewinder mass which could be calculated by using the diameter (empty hub and backing paper) and the label width. When the mass of the rewinder is known (see exemplary calculations below) and the surface speed (i.e., driver roller speed combined with driver roller diameter) of the front drive roller 172 is known then the rewinder can be controlled by the motor using a corresponding algorithm to substantially always keep a constant tension in the backing paper/liner. The algorithm must consider the rewinder diameter, the label width as well as the drive roller speed and position.

In the following, it is disclosed a rewinder that generates a slack of a controlled size in the backing paper, between the drive roller and rewinder, during backfeed of a label and reels in the slack at a known relative surface speed, between the rewinder surface speed and drive roller surface speed, regardless of whether the drive roller is standing still or accelerating during the reel in process. The backing paper slack is reeled in before the front of the label reaches the dispensing edge.

Here, at least the backing paper diameter is measured to calculate the backing paper surface speed. When the label width is considered, the rewinder approximate weight can be calculated, which allows a faster slack generation and reel control and thus faster system operation.

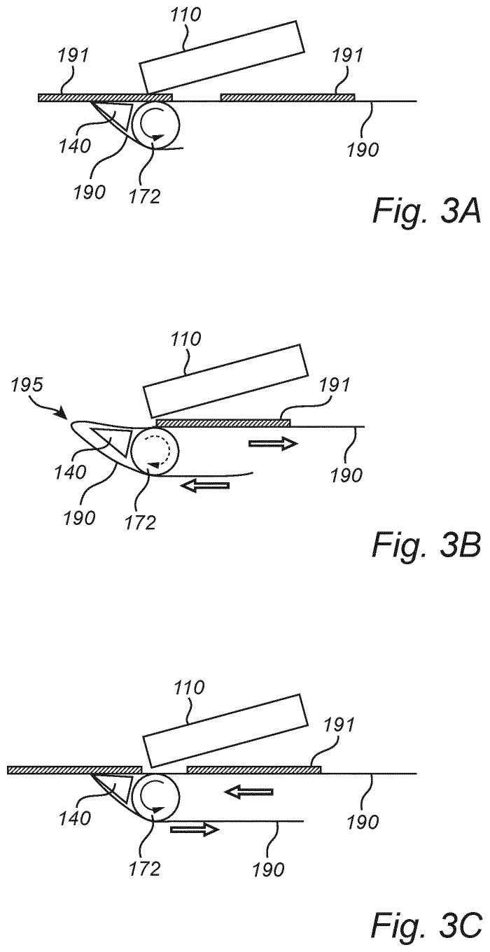

In FIGS. 3a to 3c, the printhead and dispensing portion of the printer of FIG. 1 are illustrated schematically in different operational states. The control of the rewinder spool can be split into the following substantially three steps as illustrated schematically in FIGS. 3a to 3c:
1. In FIG. 3a, the rewinder motor 132 (FIG. 2) is controlled to remain tension in the backing paper 190 during a print phase when the label 191 is transported forward. This will generate a reliable dispensing of the self-adhesive label 191. This could be achieved with torque or speed/position control of the motors depending on application. The arrows represent the movement directions of the backing paper and the drive roller.
2. In FIG. 3b, to achieve a backing paper slack 195 of known size, during the back feed phase, the rewinder motor is controlled. This allows the drive roller 172 to generate a reliable and unobstructed backfeed. The arrows represent the movement direction of the backing paper.
3. In FIG. 3c, the rewinder can be controlled to reduce the backing paper slack 195 with a known relative speed compared to the web path 192 and drive roller 172. Here the drive roller 172 may stand still or accelerated for the next label. This will remove the backing paper slack substantially quickly with limited “bouncing” before the label 191 reaches the dispensing edge and prepare for the step 1 and thus a reliable label dispensing. The arrows represent movement directions of the backing paper and the feed roller.

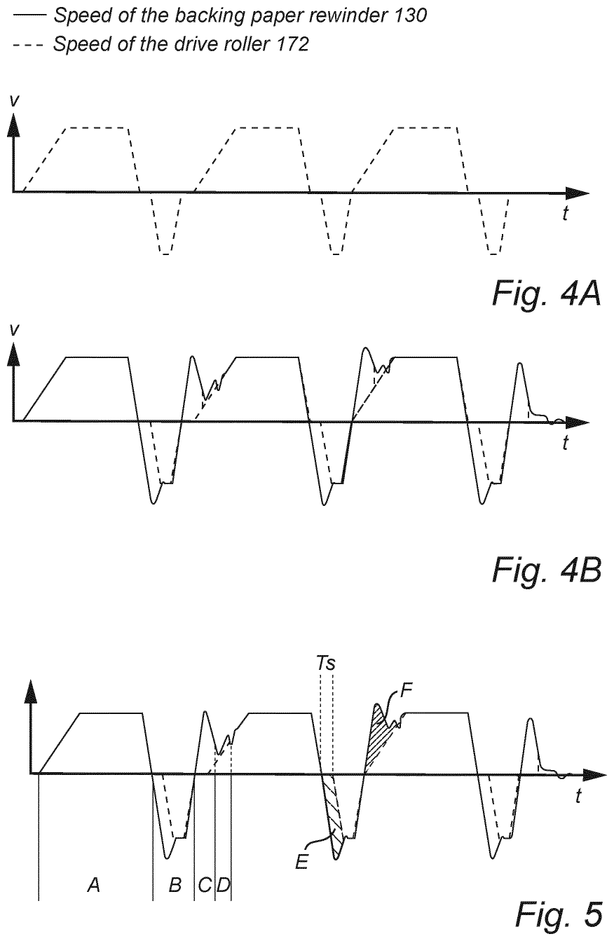

FIG. 4a is an exemplary graphical representation of the speed of the drive roller 172 over time, presented with dotted line and FIG. 4b is an exemplary graphical representation of the combined speed of the drive roller 172 (dotted line) and the speed of the rewinder 130 surface speed represented by solid line. The portion over the timeline is positive speed and below the timeline negative speed.

FIG. 5 is an exemplary graphical representation of the combined speed of the drive roller 172 (dotted line) and the speed of the rewinder 130 surface speed represented by solid line, with details of the graph indicated.

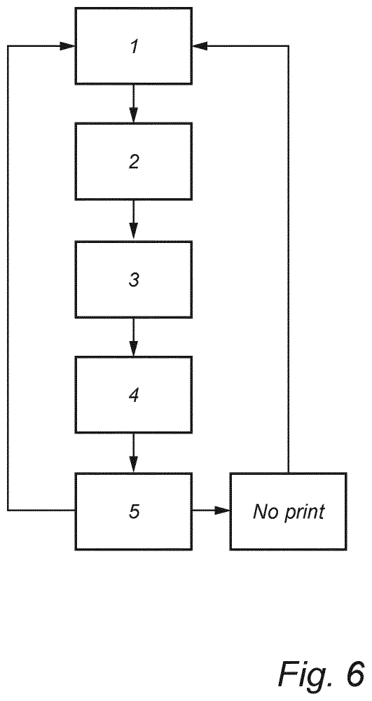

The following exemplary process may be conducted according to FIGS. 5 and 6:
1. Section A represents when a print cycle is active, a label is fed forward and provided with possible print. There is no slack (left) in the backing paper from a previous possible backfeed cycle. During this section the label/rewinder may be either torque controlled or speed/position controlled. Speed/position control is used when for example a printhead or ribbon save function (see for example parallel patent application titled “A THERMAL PRINTER AND METHOD”, Application No. PCT/EP2023/071288, incorporated herein by reference) is used, where the printhead can be lifted from the drive roller, i.e., no contact between the print elements and the web, and the speed of the backing paper is thus mainly determined by the rewinder 130 rather than by the drive roller 172. A torque control can be used in the other cases when the backing paper speed is mainly determined by the drive roller. The total rewinder torque consists of two parts a first torque (Tₘₐ) and a second torque (T_{mf}). Torque Fₐ is the torque needed to accelerate the total rewinder mass so that the backing paper speed matches the drive roller surface speed. The torque Ft is the torque needed to create the desired constant force in the backing paper to create accurate label feeding and reliable label dispensing. The torques are applied by the rewinder driving motor 132.
2. When the drive roller 172 stops after having printed and fed a label, e.g., onto a label applicator, the backing paper slack size is reset, i.e. the slack is removed. A delay time Tₛ is started to allow start building up a backing paper slack 195. For this, the rewinder 130 starts rotating backwards by means of the motor 132, position controlled, with a slack size X mm as target value. For example, a PID (proportional-integral-derivative) regulator or controller may be used for controlling the length of the slack. As the backing paper slack is now being built up between the dispensing edge (substantially tip of the peel bar) and the rewinder 130, the backfeed starts. The rewinder diameter (D) can be used to calculate the backing paper slack size or length. The shaded area E represents the backing paper slack length build up. By using both the rewinder 130 diameter and the label width, additional parameters can be used for the rewinder motor 132 control.
3. When Tₛ has passed, the drive roller 172 will start rotating backwards to move back the start of the next label to the print position of the print head 110, in order to prepare for the next print out.
4. When the drive roller stops after its backfeed, the slack size target value changes from X mm to 0 mm and section C starts.
5. When backing paper slack size is reduced to Y mm (<X), then section D is entered. In section D, the rewinder 130 is speed controlled. The target speed relates to the backing paper speed which is equal to the rewinder surface speed. The target value is 100+Z % of the drive roller print speed. Note that this speed is =0 if no new print cycle is started (end portion of graph). This will cause the backing paper to tense at a controlled speed, which in return will prevent the “bouncing”. Backing paper slack length reel back is represented by shaded section F.

Thus, there may occur two different scenarios: one scenario where a new print is started but the slack in the backing paper is not yet fully removed but is being removed; another scenario where a new print is started and the slack in the backing paper is fully eliminated. In both scenarios a combination of torque and speed control is useful. In the first scenario to reel in at a defined speed and then the last tension with torque. In the second scenario to use speed when printhead is lifted, i.e. pressure from the printhead on the label is reduced, e.g. due to non-printing, but to use torque when the printhead is down and the speed is controlled by the print/drive roller.

The surface speed (Vₛ) of the drive roller may be calculated by multiplying the circumference of the roller by the its angular speed, measured in rpm: Vₛ=π*d*rpm.

As mentioned previously, the label width can be used in combination with the rewinder diameter (D) to optimize the process. The rewinder may be torque controlled during print period but speed controlled when tension is regained. Diameter D may affect both a lever length needed to translate the motor torque to backing paper tension, as well as the weight of the rewinder and thereby the torque needed to accelerate the rewinder during start and stop. When calculating the torque needed to accelerate the rewinder, the rewinder diameter “D” is as well used to calculate the lever point for the mass added by the rewound backing paper.

Thus, the rewinder mass is calculated using the winded label diameter and using the label width. Using the mass of the rewinder and the speed of the front drive roller, the rewinder can be controlled by the motor 132 using by means of the controller to substantially always keep a constant tension in the backing paper/liner. The controller considers the rewinder diameter, the label width as well as the drive roller speed and position.

In one exemplary embodiment, at least the backing paper diameter can be used to calculate the backing paper surface speed. The rewinder diameter “D” may for example be calculated when the backing paper is expected to be tensioned the rewinder is torque controlled and the backing paper speed is approximately equal to the surface speed of the drive roller (Vₛ). All backing paper transported by the drive roller may then be expected to be rewound along the perimeter of the rewinder. The calculation can then be done by measuring and comparing an amount of resulting rewinder rotation to a driven amount of drive roller rotation. The comparison could be done for example after a defined amount of rewinder rotation, a defined amount of drive roller rotation or after a defined time. When the label width is considered, the rewinder approximate weight is calculated by the controller, which allows a faster slack generation and reel control and thus faster system operation. Considering the weight, it may allow for the controller to add extra torque during acceleration and reduce the torque during deceleration. This leads to a constant force in the backing paper which leads to reduced slippage between the drive roller and the backing paper which reduces the wear on the drive roller. The increased torque and thereby maintained pulling force in the backing paper during acceleration may secure good label dispensing. The reduced torque and thereby maintained pulling force in the backing paper during deceleration will reduce the slippage between the drive roller and the backing paper. The constant pulling force and reduced slippage also allows for faster acceleration and deceleration.

In one exemplary embodiment, the backing paper width can be measured using, e.g., a potentiometer at the feed label holder which measures the distance between the supports, a laser distance meter, scanning information on the label stock or provided by an operator.

The formula (1) may be used for measuring the length dₛ of the slack over time (t) with respect to variable speed v(t) of the drive roller may be calculated by:

$${d}_{s} = \int [ {t}_{1} to {t}_{2} ] v ( t ) dt \qquad ( 1 )$$

Wherein t₁ represents the initial time, t₂ represents the final time, v(t) represents the speed of the drive roller at any given time t, and dt represents an infinitesimally small-time interval.

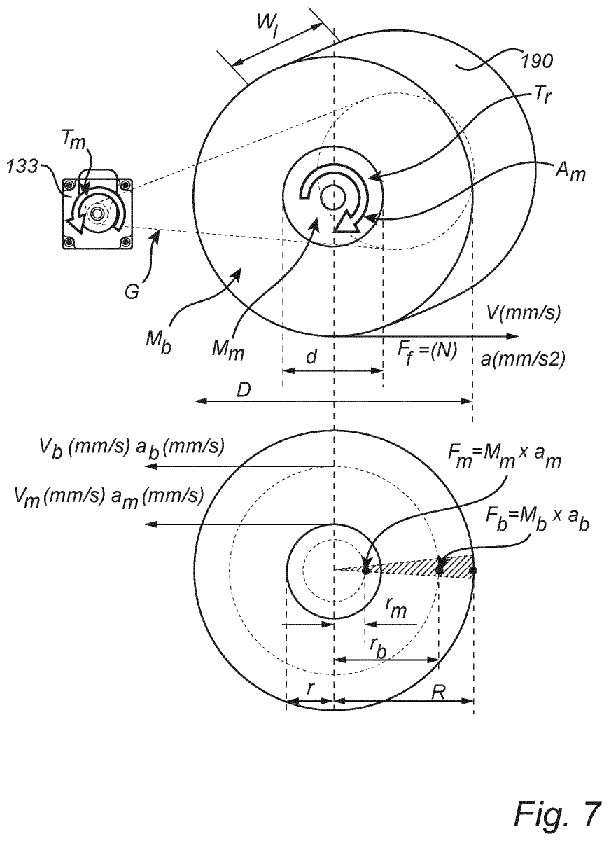

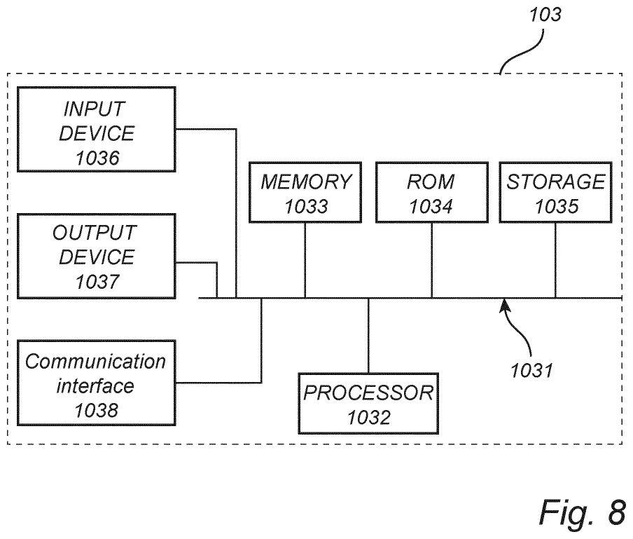

FIG. 7 is a representation of the backing paper 190 rewinder for exemplary calculation of the acceleration backing paper. The rewinder is operated by the motor 133.

There are two masses that need to be accelerated and decelerated by the system (motor). One is the mass of the moving mechanics (Mm). The system will experience this mass having a combined centre of gravity during acceleration located a distance rm from the rotation center of the rewinder. This mass will be relatively small.

The other and greater mass is generated by the rewound backing paper. The start diameter of the rewound backing paper is named “d” and the current diameter if the rewound backing paper is named “D”.

Location of radius for the center of gravity for the backing paper when accelerated (r_{b}): For a section of a circle, the center of gravity is located a distance of ⅔ of the radius of the original circle away from the centre of the original circle.

When accelerated the centre of gravity will be placed somewhere between “r” and “R”. If the start dimeter would have been 0 then r_{b} would have been ⅔×R. Now the absence of backing paper inside of “d” must be taken into consideration. This can be done using cut through area generated by the radiuses and take into consideration the torque generated by the masses behind sectors and then:

$$\begin{matrix}( {D}^{2} Π / 4 - {d}^{2} Π / 4 ) \times {r}_{b} = ( {D}^{6} Π / 4 \times 2 / 3 R ) - ( {d}^{2} Π / 4 \times 2 / 3 r ) = ( {D}^{2} Π / 4 \times 1 / 3 D ) - ( {d}^{2} Π / 4 \times 1 / 3 d ) = > \\ {r}_{b} = ( ( {D}^{2} Π / 4 \times 1 / 3 D ) - ( {d}^{2} Π / 4 \times 1 / 3 d ) ) / ( {D}^{2} Π / 4 - {d}^{2} Π / 4 ) \\ {r}_{b} = ( ( {D}^{2} Π / 4 \times 1 / 3 D ) - ( {d}^{2} Π / 4 \times 1 / 3 d ) ) / ( {D}^{2} Π / 4 - {d}^{2} Π / 4 ) \\ {r}_{b} = ( ( {D}^{3} Π / 12 ) - ( {d}^{3} Π / 12 ) ) / ( {D}^{2} Π / 4 - {d}^{2} Π / 4 ) \\ {r}_{b} = Π / 12 \times ( {D}^{3} - {d}^{3} ) / Π / 4 \times ( {D}^{2} - {d}^{2} ) \\ {r}_{b} = 1 / 3 ( {D}^{3} - {d}^{3} ) / ( {D}^{2} - {d}^{2} )\end{matrix}$$

The rotating mass generated by the rewound backing paper is calculated as:

$${M}_{b} = {A}_{b} \times {W}_{I} \times {D}_{F}$$

Wherein
A_{b}=The rewound backing paper cut through area. (m²)=(D²π/4)−(d²π/4)
Wᵢ=The width of the backing paper≈label width (m)
DF=Backing paper density factor (kg/m³)

$$= > {M}_{b} = ( {D}^{2} Π / 4 ) - ( {d}^{2} Π / 4 ) \times {W}_{I} \times DF$$

The acceleration at center of gravity for the backing paper (ab) is relative to the known acceleration of the backing paper (a) as follows:

$${a}_{b} = ( {r}_{b} / R ) \times a$$

Therefore, according to Newton's second law (F=m×a) the torque needed to accelerate the backing paper alone is:

$$\begin{matrix}{T}_{b} ( Nm ) = {F}_{b} \times {r}_{b} = {M}_{b} \times {a}_{b} \times {r}_{b} \\ {T}_{b} ( Nm ) = {M}_{b} \times {a}_{b} \times {r}_{b}\end{matrix}$$

The motor 133 drives the rewinder with a gearing factor “G”. The torque the motor needs to provide (T_{mb}) to accelerate the backing paper alone is therefor:

$$\begin{matrix}{T}_{mb} ( Nm ) = ( {M}_{b} \times {a}_{b} \times {r}_{b} ) \times G \\ {T}_{mb} ( Nm ) = ( ( {D}^{2} Π / 4 ) - ( {d}^{2} Π / 4 ) \times {W}_{I} \times DF \times ( {r}_{b} / R ) \times a \times 1 / 3 ( {D}^{3} - {d}^{3} ) / ( {D}^{2} - d 2 ) ) \times G\end{matrix}$$

As an example, the following parameters could be used:

$$\begin{matrix}D = 0.22 m = > R = 0.11 m \\ d = 0.04 m \\ {W}_{I} = 0.15 m \\ a = 2 m / {s}^{2} \\ DP = 1000 kg / {m}^{3} \\ {M}_{m} = 2 kg \\ G = 1 / 8 ( motor gear size / rewind gear size ) \\ {R}_{b} = 0.03 m \\ {F}_{p} = 10 N ( Desired constant force in the background paper during print operation )\end{matrix}$$

The example gives the following values:

$$\begin{matrix}{A}_{b} = ( {D}^{2} Π / 4 ) - ( {d}^{2} Π / 4 ) = ( 0.222 Π / 4 ) - ( 0.042 Π / 4 ) = 0.0367566 {m}^{2} \\ {M}_{b} = {A}_{b} \times {W}_{I} \times DF = 0.0367566 \times 0.15 \times 1000 = 5.51 kg \\ {a}_{b} = ( {r}_{b} / R ) \times a = ( 0.0753846 / 0.11 ) \times 2 = 1.37 m / {s}^{2} \\ {a}_{m} = ( {r}_{m} / R ) \times a = ( 0.03 / 0.11 ) \times 2 = 0.545 m / {s}^{2} \\ {r}_{b} = 1 / 3 ( {D}^{3} - {d}^{3} ) / ( {D}^{2} - {d}^{2} ) = 1 / 3 ( 0.223 - 0.043 ) / ( 0.222 - 0.042 ) = 0.0753846 m \\ {T}_{mb} ( Nm ) = ( {M}_{b} \times {a}_{b} \times {r}_{b} ) \times G = ( 5.51 \times 1.371 \times 0.075 ) \times ( 1 / 8 ) = 0.0711 Nm \\ {T}_{mm} ( Nm ) = ( {M}_{m} \times {a}_{m} \times {r}_{m} ) \times G = ( 2 \times 0.545 \times 0.03 ) \times ( 1 / 8 ) = 0.0041 Nm\end{matrix}$$

Consequently, the total motor torque needed to accelerate the constant moving mass and the accumulated backing paper in this example is:

$${T}_{ma} ( Nm ) = {T}_{nb} + {T}_{mm} = 0.0711 + 0.0041 = 00752 Nm$$

The motor torque needed to create a desired force in the backing paper at constant speed in this example is:

$${T}_{mf} ( Nm ) = {F}_{f} \times R \times G = 10 \times 0.11 \times ( 1 / 8 ) = 0.1375 Nm$$

Thus, the total torque the motor needs to provide during acceleration in order to maintain a constant desired force in the backing paper in this example is:

$${T}_{m} ( Nm ) = {T}_{ma} + {T}_{mf} = 0.0752 + 0.1375 = 0.2127 Nm = 21.27 Ncm$$

In some exemplary embodiments, when the printhead is not lifted the method of the disclosure may comprise:
during a print operation:
   rewinding the carrier by means of the rewinder with controlled torque;
   if an ongoing extension removal operation:
      in a first period of time rewind with a controlled speed, and
      in a second period of time rewind with a second speed higher than a surface speed of the drive roller;
during an optional non-printing operation:
   rewinding the carrier by means of the rewinder by controlling the speed;
during a backfeed operation:
   creating an extension, substantially with known size, in the carrier by controlling the speed of the rewinder in a opposite direction; and
during an extension removal operation:
   rewinding the carrier with the rewinder, wherein the rewinder:
      in a first period of time has a controlled speed, and
      in a second period of time has a second speed higher than a surface speed of the drive roller.

In some exemplary embodiments, when the printhead lifted (less pressure on ribbon) the method of the disclosure may comprise:
during a print operation:
   rewinding the carrier by means of the rewinder with controlled torque;
   if an ongoing extension removal operation:
      in a first period of time rewind with a controlled speed, and
      in a second period of time rewind with a second speed higher than a surface speed of the drive roller;
during a non-printing operation:
   rewinding the carrier by means of the rewinder by controlling the speed;
during a backfeed operation:
   creating an extension, substantially with known size, in the carrier by controlling the speed of the rewinder in a opposite direction; and
during an extension removal operation:
   rewinding the carrier with the rewinder speed or torque controlled.

FIG. 8 is an exemplary controller 103 communicating with and/or controlling various units of the exemplary printer, e.g., such as a printer described previously in the disclosure. The controller 103 may communicate with various sensors of the printer, such as the encoder for motors 132, 152, 162, and 170. The controller may be stand alone or be part of the printer controller as mentioned previously. The controller 103 as described earlier in which methods and systems described herein may be implemented, may include a bus 1310, a processor 1032, a memory 1033, a read only memory (ROM) 1034, a storage device 1350, an input device 1035, an output device 1037, and a communication interface 1038. The bus 1031 permits communication among the components of controller 103. The bus may be any of several types of bus structures that may further interconnect to a memory bus (with or without a memory controller), a peripheral bus, and/or a local bus using any of a variety of bus architectures. The controller 103 may also include one or more power supplies (not shown). One skilled in the art would recognize that controller 103 may be configured in a number of other ways and may include other or different elements.

The processor 1032 may include any type of processor or microprocessor that interprets and executes instructions. The processor 1032 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processor may further include computer executable code that controls operation of the programmable device. The processor 1032 may also include logic that is able to receive and compile instructions and interpret different signal, and also generate output to, for example, a speaker, a display, etc.

The memory 1033 may include a random-access memory (RAM) or another dynamic storage device that stores information and instructions for execution by processor 1032. Memory 1033 may also be used to store temporary variables or other intermediate information during execution of instructions by processor 1032. The memory 1033 may be one or more devices for storing data and/or computer code for completing or facilitating methods described herein. The memory may include database components, object code components, script components, or other types of information structure for supporting the various activities herein. Any distributed or local memory device may be utilized with the systems and methods of this description. The memory may be communicably connected to the processor device (e.g., via a circuit or any other wired, wireless, or network connection) and may include computer code for executing one or more processes described herein. The memory may include non-volatile memory 1034 (e.g., read-only memory (ROM), erasable programmable read-only memory (EPROM), electrically erasable programmable read-only memory (EEPROM), etc.), and volatile memory (e.g., random-access memory (RAM)), or any other medium which can be used to carry or store desired program code in the form of machine-executable instructions or data structures and which can be accessed by a computer or other machine with a processor. A basic input/output system (BIOS) may be stored in the non-volatile memory 1034 and can include the basic routines that help to transfer information between elements within the controller.

ROM 1034 may include a conventional ROM device and/or another static storage device that stores static information and instructions for processor 1032. Storage device 1350 may include a magnetic disk or optical disk and its corresponding drive and/or some other type of magnetic or optical recording medium and its corresponding drive for storing information and instructions. Storage device 1350 may also include a flash memory (e.g., an electrically erasable programmable read only memory (EEPROM)) device for storing information and instructions.

Input device 1035 may include one or more conventional mechanisms that permit a user to input information to the controller 103, such as a keyboard, a keypad, a directional pad, a mouse, a pen, voice recognition, a touch-screen and/or biometric mechanisms, etc. Output device 1037 may include one or more conventional mechanisms that output information to the user, including a display, a printer, one or more speakers, etc. Communication interface 1038 may include any transceiver-like mechanism that enables controller 103 to communicate with other devices and/or systems. For example, communication interface 1038 may include a modem or an Ethernet interface to a LAN. Alternatively, or additionally, communication interface 1038 may include other mechanisms for communicating via a network, such as a wireless network. For example, communication interface may include a radio frequency (RF) transmitter and receiver and one or more antennas for transmitting and receiving RF data.

The controller 103, consistent with the disclosure, provides a platform through which the various functions of the label printer and especially operation of the motors are controlled. The controller 103 may also display information associated with the label application status of printer relevant information.

According to an exemplary implementation, controller 103 may perform various processes in response to processor 1032 executing sequences of instructions contained in memory 1033. Such instructions may be read into memory 1033 from another computer-readable medium, such as storage device 1350, or from a separate device via communication interface 1038. It should be understood that a computer-readable medium may include one or more memory devices or carrier waves. Execution of the sequences of instructions contained in memory 1033 causes processor 1032 to perform the acts that have been described. In alternative embodiments, hard-wired circuitry may be used in place of or in combination with software instructions to implement aspects consistent with the disclosure. Thus, the disclosure is not limited to any specific combination of hardware circuitry and software.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the disclosure may be implemented at least in part by means of both hardware and software, and that several “means”, “units” or “devices” may be represented by the same item of hardware.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

Software and web implementations of various embodiments of the disclosed methods can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A method in a label printer (100), the label printer at least comprising:
a label supply spool (120) configured to supply a label web comprising a label (191) and a carrier (191);
a label rewinder (130) configured to rewind at least the carrier;
a drive roller (172);
the method comprising:
operating the label rewinder in an opposite direction to a rewind direction and building or continue to build an extension (195) on the carrier between the drive roller (172) and the carrier rewinder (130) during a backfeed operation of the label web;
performing a backfeed operation by rotating the drive roller (172) in a direction opposite to the print operation direction until a next label is displaced back to a start print position;
stopping the drive roller after backfeed when a length of the extension (195) is reduced; and
rewind with the rewinder (130) in the rewinder operation direction causing the carrier to tense.

2. The method of claim 1, further comprising starting the rewinder (130) in rewinder operation direction causing the carrier to tense is in controlled speed.

3. The method of claim 1, wherein when a print cycle is active, the extension of the carrier from a previous backfeed cycle is removed, whereby the carrier rewinder is either torque controlled or speed controlled.

4. The method of claim 3, using a torque control when the carrier speed is mainly determined by the drive roller.

5. The method of claim 4, wherein a total rewinder torque consists of two torques: a first torque (Tₘₐ) and a second torque (T_{mf}), wherein the first torque (Tₘₐ) is the torque needed to accelerate a total rewinder mass so that the carrier speed matches the drive roller surface speed, and the second torque (T_{mf}) is the torque needed to create a desired constant force in the carrier to create an accurate label feeding and reliable label dispensing.

6. The method according to any of previous claims, wherein when the drive roller (172) stops after a printing operation, the carrier extension is reset, whereby a delay time (Tₛ) is started to enable starting to generate the extension (195).

7. The method of claim 6, wherein the carrier rewinder (130) is rotated backwards with an extension length (X) as a target value.

8. The method according to any of previous claims, wherein a carrier rewinder diameter (D) is used to calculate the carrier extension length.

9. The method of claim 8, wherein the rewinder (130) diameter, comprising rewinder hub diameter and rewind carrier diameter, and a label width are used for the rewinder motor control.

10. The method according to any of previous claims, wherein when a time period (Tₛ) has passed, the drive roller (172) starts rotating backwards to move back a start point of a next label to the print position.

11. The method according to claim 10, wherein when the drive roller stops after its backfeed, an extension length target value (X) changes to substantially zero (0).

12. The method according to claim 11, wherein when the carrier extension length is reduced to a second length (Y), wherein Y<X, the carrier rewinder (130) is speed controlled.

13. The method according to any of claims 10-12, wherein the target speed relates to the carrier speed which is equal to a rewinder surface speed.

14. The method according to any of claims 10-13, wherein the target value is 100+Z % of a drive roller print speed.

15. The method according to any of claims 1-14, using a label width in combination with a carrier rewinder diameter to optimize the backing label extension process.

16. The method according to claim 1, wherein the rewinder may be torque controlled during print period but speed controlled when a tension is regained.

17. The method according to any of claims 1-16, comprising calculating label rewinder mass using winded label diameter and using label width, using the mass of the label rewinder and a speed of the front drive roller, to control the label rewinder to substantially always keep a constant tension in the carrier.

18. The method according to claim 17, wherein at least the carrier diameter is measured to calculate the carrier surface speed, and when the label width is considered, the label rewinder's approximate weight is calculated, which allows a faster slack generation and reel control and thus faster system operation.

19. A method of printing a label in a label printer, the label printer comprising:
a label supply spool (120) configured to supply a label web comprising a label (191) attached to a carrier (191);
a label rewinder (130) configured to receive at least the carrier of the label web and rotationally operatable by a label rewinder motor (132);
a drive roller (172),
the method comprising:
during a print operation:
rewinding the carrier by means of the rewinder with controlled torque;
if an ongoing extension removal operation:
in a first period of time rewind with a controlled speed, and
in a second period of time rewind with a second speed higher than a surface speed of the drive roller;
during an optional non-printing operation:
rewinding the carrier by means of the rewinder by controlling the speed;
during a backfeed operation:
creating an extension, substantially with known size, in the carrier by controlling the speed of the rewinder in a opposite direction; and
during an extension removal operation:
rewinding the carrier with the rewinder, wherein the rewinder:
in a first period of time has a controlled speed, and
in a second period of time has a second speed higher than a surface speed of the drive roller.

20. A method of printing a label in a label printer, the label printer comprising:
a label supply spool (120) configured to supply a label web comprising a label (191) attached to a carrier (191);
a label rewinder (130) configured to receive at least the carrier of the label web and rotationally operatable by a label rewinder motor (132);
a drive roller (172),
the method comprising:
during a print operation:
rewinding the carrier by means of the rewinder with controlled torque;
if an ongoing extension removal operation:
in a first period of time rewind with a controlled speed, and
in a second period of time rewind with a second speed higher than a surface speed of the drive roller;
during a non-printing operation:
rewinding the carrier by means of the rewinder by controlling the speed;
during a backfeed operation:
creating an extension, substantially with known size, in the carrier by controlling the speed of the rewinder in a opposite direction; and
during an extension removal operation:
rewinding the carrier with the rewinder speed or torque controlled.

21. A label printer (100) at least comprising:
a label supply spool (120) configured to supply a label web comprising a label (191) and a carrier (191);
a label rewinder (130) configured to rewind at least the carrier;
a drive roller (172); and
a controller (103);
wherein the controller is configured to:
instruct the label rewinder to operate in an opposite direction to a rewind direction and building or continue to build an extension (195) on the carrier between the drive roller (172) and the carrier rewinder (130) during a backfeed operation of the label web;
instruct the rewinder to a backfeed operation by rotating the drive roller (172) in a direction opposite to the print operation direction until a next label is displaced back to a start print position;
stop the drive roller after backfeed when a length of the extension (195) is reduced; and
instruct the rewinder (130) to rewind in the rewinder operation direction causing the carrier to tense.

22. A control unit (103) for enabling feed of a label in a label printer, wherein the control unit is arranged to perform the method according to any one of claims 1-21.

23. A computer program product comprising program code for performing, when executed by a processing circuitry, the method according to any one of claims 1-21.

24. A non-transitory computer-readable storage medium comprising instructions, which when executed by a processing circuitry, cause the processing circuitry to perform the method according to any one of claims 1-21.
